(19) United States
(12) Patent Application Publication
(10) Pub. No.: US 2018/0074162 A1
(43) Pub. Date: Mar. 15, 2018

(54) System and Methods for Identifying an Action Based on Sound Detection

(71) Applicant: Wal-Mart Stores, Inc., Bentonville, AR (US)

(72) Inventors: Matthew Allen Jones, Bentonville, AR (US); Aaron James Vasgaard, Fayetteville, AR (US); Nicholaus Adam Jones, Fayetteville, AR (US); Robert James Taylor, Rogers, AR (US)

(21) Appl. No.: 15/698,052

(22) Filed: Sep. 7, 2017

Related U.S. Application Data
(60) Provisional application No. 62/393,763, filed on Sep. 13, 2016.
(60) Provisional application No. 62/393,772, filed on Sep. 13, 2016.
(60) Provisional application No. 62/393,773, filed on Sep. 13, 2016.

(51) Int. Cl. G01S 5/14; G08B 23/00; G08B 3/10

(52) U.S. Cl. CPC G01S 5/14; G08B 3/10; G08B 23/00

(57) ABSTRACT

Described in detail herein are methods and systems for identifying actions based on detected sounds in a facility. An array of microphones can be disposed in a facility. The microphones can detect various sounds and encode the sounds in an electrical signal and transmit the sounds to a computing system. The computing system can determine the sound signature of each sound and based on the sound signature the chronological order of the sounds and the time interval in between the sounds the computing system can determine the action being performed causing the sounds.

### CROSS-REFERENCE TO RELATED PATENT APPLICATION

This application claims priority to U.S. Provisional Application No. 62/393,763 filed on Sep. 13, 2016, U.S. Provisional Application No. 62/393,772 filed on Sep. 13, 2016, and U.S. Provisional Application No. 62/393,773 filed on Sep. 13, 2016, the content of each is hereby incorporated by reference in its entirety.

### BACKGROUND

It can be difficult to keep track of various events going on in a large facility.

### BRIEF DESCRIPTION OF DRAWINGS

Illustrative embodiments are shown by way of example in the accompanying drawings and should not be considered as a limitation of the present disclosure:

FIG. 1 is a block diagram of microphones disposed in a facility according to the present disclosure;

FIG. 2 illustrates an exemplary action identification system in accordance with exemplary embodiments of the present disclosure;

FIG. 3 illustrates an exemplary computing device in accordance with exemplary embodiments of the present disclosure;

FIG. 4 is a flowchart illustrating an action identification system according to exemplary embodiments of the present disclosure;

FIG. 5 is a flowchart illustrating an action identification system according to exemplary embodiments of the present disclosure; and

FIG. 6 is a flowchart illustrating a process implemented by an action identification system according to exemplary embodiments of the present disclosure.

### DETAILED DESCRIPTION

Described in detail herein are methods and systems for identifying actions based on detected sounds in a facility. For example, action identification systems and methods can be implemented using an array of microphones disposed in a facility, a data storage device, and a computing system operatively coupled to the microphones and the data storage device.

The array of microphones can be configured to detect various sounds, which can be encoded in an electrical signal that are output by the microphones. For example, the microphones are configured to detect sounds and output time varying electrical signals upon detection of the sounds. The microphones can be configured to detect intensities, amplitudes, and frequencies of the sounds and encode the intensities, amplitudes, and frequencies of the sounds in the time varying electrical signals. The microphones can transmit the (time varying) electrical signals encoded with the sounds to a computing system.

The computing system can be programmed to receive the time varying electrical signals from the microphones, identify the sounds detected by the microphones based on the time varying electric signals, determine time intervals between the sounds encoded in the time varying electrical signals, identify an action that produced at least some of the sounds in response to identifying the sounds and determining the time intervals between the sounds.

The computing system can determine sound signatures of each sound based on the time varying electrical signals to identify the sounds. The sound signatures can be determined based on the intensity, amplitude, and frequency of the sounds encoded in each of the time varying electrical signals. The computing system can discard electrical signals received from one or more of the microphones in response to a failure to identify at least one of the sounds represented by the at least one of the electrical signals. In some embodiments, the computing system can be programmed to determine a distance between at least one of the microphones and an origin of at least one of the sounds based on the intensity of the at least one of the sounds detected by at least a subset of the microphones.

The computing system can determine a chronological order in which the sounds are detected by the microphones based on when the computing system receives the electrical signals. The computing system can be programmed to identify the action that produced at least some of the sounds based on matching the chronological order in which the sounds are detected to a set of sound patterns. The computing system is programmed to identify the action that produced at least some of the sounds based on the chronological order matching a threshold percentage of a sound pattern in a set of sound patterns.

Based on the sound signatures, a chronological order in which the sounds occur, an origin of the sounds, and/or a time interval between consecutive sounds, the computing system can determine an action being performed that caused the sounds. Upon identifying an action corresponding to the sounds, the computing system can perform one or more operations, such as issuing alerts.

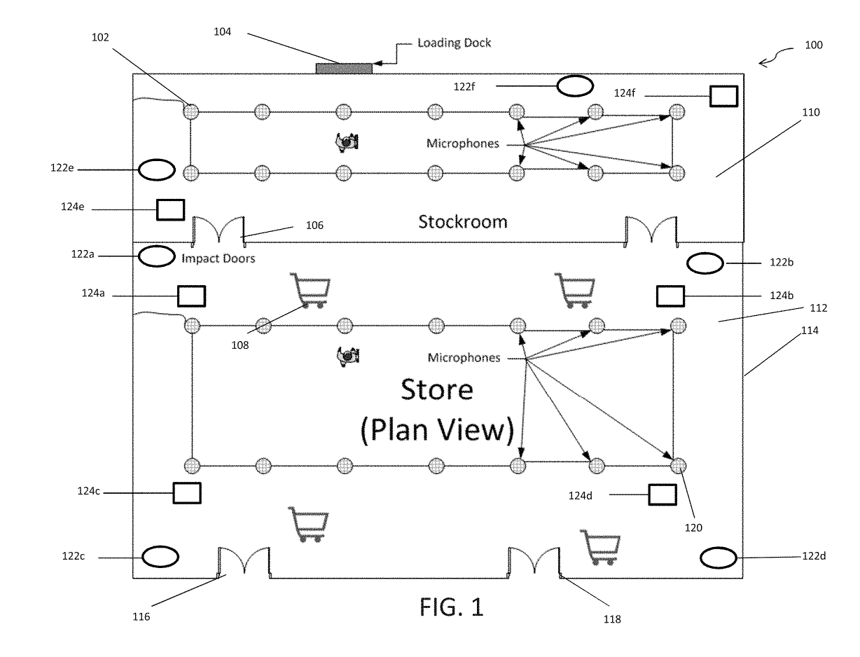

FIG. 1 is a block diagram of an array microphones 102a and 102b disposed in a facility 114 according to the present disclosure. The microphones 102a can be disposed in first location 110 of the facility 114 and the microphones 102b can be disposed in a second location 112 of the facility 114. The microphones 102a and 102b can be disposed at a predetermined distance of one another and can be disposed throughout the first and second locations 110 and 112. The microphones 102a and 102b can be configured to detect sounds in the first location and second location 110 and 112. Each of the microphones 102a and 102b in the array can have a specified sensitivity and frequency response for detecting sounds. The microphones 102a and 102b can detect the intensity or amplitude of the sounds, which can be used to determine a distance between the microphones and a location where the sound was produced (e.g., a source or origin of the sound). For example, microphones closer to the source or origin of the sound can detect the sound with greater intensity or amplitude than microphones that are farther away from the source or origin of the sound. A location of the microphones 102a and 102b that are closer to the source or origin of the sound can be used to estimate a location of the origin or source of the sound.

The first location 110 can be a room in a facility. The room can include doors 106 and a loading dock 104. The room can be adjacent to the second location 112. Various physical objects such as carts 108 can be disposed in the second location 112. The microphones 102a can detect sounds of the doors, sounds generated at the loading dock and the sounds generated by physical objects entering from the second location 112 to the first location 110. The second location can include a first and second entrance door 116 and 118. The first and second entrance doors 116 and 118 can be used to enter and exit the facility. Image capturing devices 122a-f and light sources 124a-f can be disposed throughout the first and second locations 110 and 112.

As an example, a physical object can drop on the floor and break in the second location 112. At least a subset of the microphones 102b in the array of microphones 102b can detect the sounds created by the physical object dropping on the floor and breaking. Each of the microphones 102b in at least the subset can detect intensities, amplitudes, and/or frequency for each sound generated in the second location 112. Because the microphones 102b are geographically distributed within the second location 112, microphones in the subset that are closer to the location at which the physical object was dropped can detect the sounds with greater intensities or amplitudes as compared to microphones that are farther away from the dropped physical object. As a result, the microphones 102b can detect the same sounds, but with different intensities or amplitudes based on a distance of each of the microphones to the physical object. Thus, a first one of the microphones disposed positioned proximate to the location at which the physical object was dropped can detect a higher intensity or amplitude for a sound emanating from the physical object falling on the floor and breaking than a second one of the microphones 102b that is disposed farther away from the physical object than the first one of the microphones. The microphones 102b can also detect a frequency of each sound detected. The microphones 102b can encode the detected sounds (e.g., intensities or amplitudes and frequencies of the sound in time varying electrical signals). The time varying electrical signals can be output from the microphones 102b and transmitted to a computing system for processing.

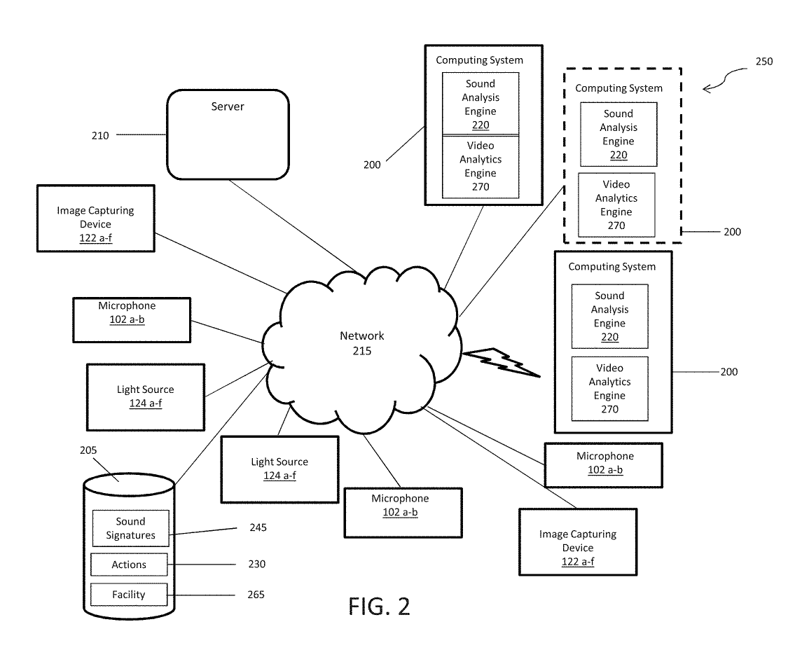

FIG. 2 illustrates an exemplary sound identification system 250 in accordance with exemplary embodiments of the present disclosure. The action identification system 250 can include one or more databases 205, one or more servers 210, one or more computing systems 200, the microphones 102a-b, image capturing devices 122a-f, and light sources 124a-f. In exemplary embodiments, the computing system 200 can be in communication with the databases 205, the server(s) 210, and the microphones 102a-b, image capturing devices 122a-f, and light sources 124a-f via a communications network 215. The computing system 200 can implement at least one instance of the sound analysis engine 220.

In an example embodiment, one or more portions of the communications network 215 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The server 210 includes one or more computers or processors configured to communicate with the computing system 200 and the databases 205, via the network 215. The server 210 hosts one or more applications configured to interact with one or more components computing system 200 and/or facilitates access to the content of the databases 205. In some embodiments, the server 210 can host the sound analysis engine 220 or portions thereof. The databases 205 may store information/data, as described herein. For example, the databases 205 can include an actions database 230, sound signatures database 245 and the facilities database 265. The actions database 230 can store sound patterns (e.g., sequences of sounds or sound signatures) associated with known actions that occur in a facility. The sound signature database 245 can store sound signatures based on amplitudes and frequencies for of known sounds. The facilities database 265 can store the locations of the microphones 102a-b, the image capturing devices 122a-f and the light sources 124a-f. The databases 205 and server 210 can be located at one or more geographically distributed locations from each other or from the computing system 200. Alternatively, the databases 205 can be included within server 210.

In one embodiment, the computing system 200 can receive multiple time varying electrical signals from the microphones 102a-b, where each of the time varying electrical signals are encoded with sounds (e.g., detected intensities, amplitudes, and frequencies of the sounds). The computing system 200 can execute the sound analysis engine 220 in response to receiving the time varying electrical signals. The sound analysis engine 220 can decode the time varying electrical signals and extract the intensity, amplitude, and frequency of the sound. The sound analysis engine 220 can determine the distance of the microphones 102a-b to the location where the sound occurred based on the intensity or amplitude of the sound detected by each microphone. The sound analysis engine 220 can estimate the location of each sound based on the distance of the microphone from the sound detected by the microphone. The sound analysis engine 220 can query the sound signature database 245 using the amplitude and frequency to retrieve the sound signature of the sound. The sound analysis engine 220 can identify the sounds encoded in each of the time varying electrical signals based of the retrieved sound signature(s) and the distance between the microphone and the origins or sources of the sounds.

The computing system 200 can execute the sound analysis engine 220 to determine the chronological order in which the sounds occurred based on when the computing system 200 received each electrical signal encoded with each sound. The computing system 200, via execution of the sound analysis engine, can determine time intervals between each of the detected sounds based on the determined time intervals. The computing system 200 can execute the sound analysis engine to determine a sound pattern based on the identification of each sound, the chronological order of the sounds and time intervals between the sounds. The sound pattern can include the identification of each sound, the estimate location of each sound, the chronological order of the sound and the time interval in between each sound. In response to determining the sound pattern, the computing system 200 can query the actions database 230 using the determined sound pattern to retrieve the identification of the action being performed by matching the determined sound pattern to a sound pattern stored in the actions database 230 within a predetermined threshold amount (e.g., a percentage). In some embodiments, in response to the sound analysis engine 220 not being able to identify a particular sound, the computing system 200 can disregard the sound when determining the sound pattern. The computing system 200 can issue an alert in response to identifying the action.

In some embodiments, the sound analysis engine 220 can receive and determine that a same sound was detected by multiple microphones, encoded in various electrical signals, with varying intensities. The sound analysis engine 220 can determine the first electrical signal is encoded with the highest intensity as compared to the remaining electrical signals with the same sound. The sound analysis 220 can query the sound signature database 245 using the sound, intensity and amplitude and frequency of the first electrical signal to retrieve the identification of the sound encoded in the first electrical signal and discard the remaining electrical signals encoded with the same sound but with lower intensities than the first electrical signal.

In some embodiments, the sound analysis engine 220 can determine the determined sound pattern based on the received electrical signals includes a primary sound which matches a primary sound of a sound pattern associated with an action stored in the actions database 230. However, in response to determining the determined sound pattern does not match the chronological order of the sound pattern including the primary sound associated to the action stored in the actions database 230, the computing system 200 can issue an alert.

In one embodiment, the computing system 200 can determine the action is an accident that has occurred in the facility. For example, the computing system can determine a physical object fallen on the floor and broke based on the sounds. In some embodiments, the location and of the sound can be determined using triangulation or trilateration. For example, the sound analysis engine 220 can determine the location of the sounds based on the sound intensity detected by each of the microphones 240 able to detect the sound. Based on the locations of the microphones the sound analysis engine can use triangulation and/or trilateration to estimate the location of the sound, knowing the microphones 240 which have detected a higher sound intensity are closer to the sound and the microphones 240 that have detected a lower sound intensity are farther away.

The computing system 200 can query the facilities database 265 using the determined location of the sounds to retrieve the closest of the image capturing devices 122a-f to the location of the generated sounds and/or the closest of the light sources 124a-f to the location of the generated sounds. The computing system 200 can control the closest determined image capturing device to capture an image of the location of the generated sounds. The image capturing device can capture an image of the broken physical object and the computing system 200 can transmit the image of the of the broken physical object as an alert. In some embodiments, the computing system 200 can execute a video analytics engine 270 to analyze the image taken of the broken physical object using video analytics and/or machine vision and confirm the identified action based on the generated sounds is correct. For example, using video analytics and/or machine vision the video analytics engine 270 can recognize the physical object on the floor and various pieces of the physical object scattered along the floor in pieces. The types of machine vision or video analytics used by the video analytics engine 270 can be but are not limited to: Stitching/Registration, Filtering, Thresholding, Pixel counting, Segmentation, Inpainting, Edge detection, Color Analysis, Blob discovery & manipulation, Neural net processing, Pattern recognition, Barcode Data Matrix and “2D barcode” reading, Optical character recognition and Gauging/Metrology. In some embodiments, the computing system 200 can power on the closest determined light source to the generated sounds. The light sources 124a-f can generate a strobe effect when powered on. In some embodiments, the computing system 200 can determine the identified action is not an accident that has occurred in the facility and discard the associated electrical signals.

As a non-limiting example, the action identification system 250 can be implemented in a retail store. An array of microphones can be disposed in a stockroom of a retail store. A plurality of products sold at the retail store can be stored in the stockroom in shelving units. The stockroom can also include impact doors, transportation devices such as forklifts or cranes, and a loading dock entrance. Shopping carts can be disposed in the facility and can enter the stock room at various times. The microphones can detect sounds in the retail store including but not limited to a truck arriving, a truck unloading products, a pallet of a truck being operated unloading of the products, an empty shopping cart being operated, a full shopping cart being operated, picking tasks, sound of a fall, sound of falling physical object, sound of a squeaky floor, sound of glass breaking, and impact doors opening and closing. Picking tasks refer to removal of items/products from storage shelves or bins for placement of the items/products at another location (e.g., on the sales floor). Picking tasks can include sounds such as: a rocket cart rolling along a backroom aisle, items/products hitting each other when they are moved in the bins, and the cart hitting and opening of the impact doors.

For example, a microphone (out of the array of microphones) can detect a sound of a truck backing up toward the loading dock. The microphone can detect a sound of vehicle motion alarm (also known as backup alarm, which emits beeps or chirps as a truck backs up) generated by the truck. In another embodiment, the microphone can also detect the sound of the engine as the truck backs up. The microphone can encode the sound of the vehicle motion alarm, the intensity or amplitude of the sound of the vehicle motion alarm and the frequency of the sound of the vehicle motion alarm in a first electrical signal and transmit the first electrical signal to the computing system 200. Subsequently, after a first time interval, the microphone can detect a back door of the truck being open and a sound of a pallet being lowered. The microphone can encode the sound of the door opening and the pallet lowering (e.g., the intensity, amplitude, and frequency of the sound of the door opening and the pallet being lowered in a second electrical signal, and can transmit the second electrical signal to the computing system 200. Thereafter, the microphone can detect a sound of unloading of products from the truck. The microphone can encode the sound of the unloading of products (e.g., the intensity, amplitude, and frequency of the sound of unloading of products from the truck) in a third electrical signal and transmit the third electrical signal to the computing system 200. In some embodiments, the microphone can also detect the sound of the air brakes of the truck as it parks at the loading dock. In some embodiments different microphones from the array of microphones can detect the sounds.

The computing system 200 can receive the first, second and third electrical signals. The computing system 200 can automatically execute the sound analysis engine 220. The sound analysis engine can decode the sound, intensity and amplitude and frequency from the first second and third electrical signals. The sound analysis engine 220 can query the sound signature database 245 using the sound, intensity and amplitude decoded from the first, second and third electrical signal to retrieve the identification the sounds encoded in the first, second and third electrical signal respectively. The sound analysis engine 220 can also estimate the distance in between the microphones and an origin or source of the sounds based on intensity of each sound. The sound analysis engine can estimate the location of the sound based on the distance between the microphone and sound. The sound analysis engine 220 can transmit the identification of sounds encoded in the first, second and third electrical signal respectively to the computing system 200. For example, the sound encoded in the first electrical signal can be associated to a sound signature for a truck backing up. The sound encoded in the second electrical signal can be associated to a sound signature for opening a door of the truck and lowering a pallet.

The computing system 200 can determine the chronological order sounds based on the time the computing system 200 received the first, second and third electrical signal. For example, the computing system 200 can determine the backing up of the truck happened before the truck door was open and the pallet was lowered, which happened before the unloading of the products from the truck. The computing system 200 can determine the time interval in between the sounds based on the time the computing system received the first, second and third electrical signals. For example, the computing system 200 can determine sound of the truck backing up occurred two minutes before the pallet lowering which occurred 1 minute before the unloading of the products from the truck based on receiving the first electrical signals two minutes before the second electrical signal and receiving the third electrical signal one minute after the second electrical signal. The sound pattern can include the identification of each sound, the location of each sound, the chronological order of the sound and the time interval in between each sound. In response to determining the chronological order of the sounds and the time interval between the sounds, the computing system 200 can determine a sound pattern. The computing system 200 can query the sounds of actions database 200 using the determined sound pattern to retrieve the action which matches the determined sound pattern by a predetermined threshold amount. For example, the computing system 200 can determine the action of unloading a new shipment of product is generating the sounds encoded in the first, second and third electrical signal. The computing system 200 can transmit an alert to an employee that a new shipment is being unloaded in the stockroom. In some embodiments, the alert can be transmitted to a second system (e.g. a picking or receiving system to keep track of the products at the store). The second system can update information associated with physical objects in the database.

In another example, a microphone (out of the array of microphones) can detect a sound of a product on the sales floor falling off of the shelving unit onto the floor. The microphone can encode the sound of the product hitting the floor, the intensity or amplitude of the sound of the product hitting the floor and the frequency of the sound of the product hitting the floor in a first electrical signal and transmit the first electrical signal to the computing system 200. Subsequently, after a first time interval, the microphone can detect the glass breaking. The microphone can encode the sound of the glass breaking (e.g., the intensity, amplitude, and frequency) in a second electrical signal, and can transmit the second electrical signal to the computing system 200.

The computing system 200 can receive the first and second electrical signals. The sound analysis engine can decode the sound, intensity, amplitude and/or frequency from the first and second electrical signals. The sound analysis engine 220 can query the sound signature database 245 using the sound e.g., the intensity, amplitude, and/or frequency decoded from the first and second electrical signals to retrieve the identification the sounds encoded in the first and second electrical signals, respectively. The sound analysis engine 220 can also estimate the distance in between the microphones and an origin or source of the sounds based on intensity or amplitude of each sound. The sound analysis engine can estimate the location of the sound based on the distance between the microphone and sound. The sound analysis engine 220 can transmit the identification of sounds encoded in the first and second electrical signals, respectively, to the computing system 200. For example, the sound encoded in the first electrical signal can be associated to a sound signature for a physical object hitting the floor. The sound encoded in the second electrical signal can be associated to a sound signature for glass shattering.

As noted above, the computing system 200 can determine the chronological order sounds based on the time the computing system 200 received the first and second electrical signal. For example, the computing system 200 can determine the physical object hitting the floor happened before the glass breaking and scattering. The computing system 200 can determine the time interval between the sounds based on the time the computing system received the first and second electrical signals. For example, the computing system 200 can determine physical object hitting the floor occurred one microsecond before the glass breaking and scattering based on receiving the first electrical signals one microsecond before the second electrical signal. In response to identifying the sounds based on their signatures, determining the chronological order of the sounds, and determining the time interval between the sounds, the computing system 200 can determine a sound pattern. The computing system 200 can query actions database 200 using the determined sound pattern to retrieve the action which matches the determined sound pattern by a predetermined threshold amount (e.g., a threshold percentage). For example, the computing system 200 can determine the action of a product falling and breaking is generating the sounds encoded in the first and second electrical signal.

The computing system 200 can determine the action of the product falling and breaking is an accident that has occurred in the facility. The computing system 200 query the facilities database 265 using the determined location of the sounds to retrieve the closest of the image capturing devices 255 to the location of the generated sounds and/or the closest of the light sources 260 to the location of the generated sounds. The computing system 200 can control the closest determined image capturing device to capture an image of the location of the generated sounds. The image capturing device can capture an image of the broken product and the computing system 200 can transmit the image of the of the broken physical object as an alert to an employee of the store to clean up the broken product. In some embodiments, the computing system 200 can execute a video analytics engine 270 to analyze the image taken of the broken product using video analytics and confirm the identified action based on the generated sounds is correct. In some embodiments, the computing system 200 can power on the closest determined light source to the generated sounds. The light sources 260 can generate a strobe effect when powered on. The light sources 260 can alert the employees of the broken product and warn the customers of danger of falling/slipping on the broken product.

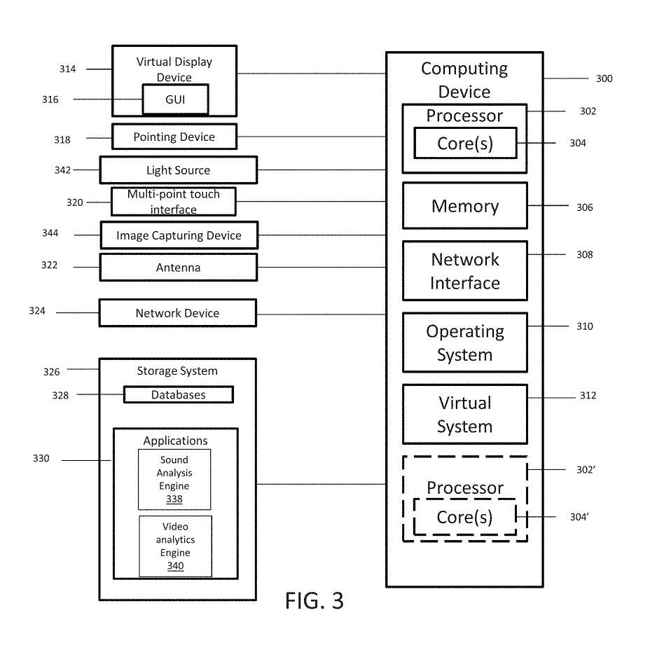

FIG. 3 is a block diagram of an example computing device 300 for implementing exemplary embodiments of the present disclosure. Embodiments of the computing device 300 can implement embodiments of the sound analysis engine. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 300 may store computer-readable and computer-executable instructions or software (e.g., applications 330 such as the sound analysis engine 220 and the video analytics engine 340) for implementing exemplary operations of the computing device 300. The computing device 300 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a single core processor or multiple core (304 and 304′) processor. Either or both of processor 302 and processor(s) 302′ may be configured to execute one or more of the instructions described in connection with computing device 300.

Virtualization may be employed in the computing device 300 so that infrastructure and resources in the computing device 300 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof.

A user may interact with the computing device 300 through a visual display device 314, such as a computer monitor, which may display one or more graphical user interfaces 316, multi touch interface 320 an image capturing device 344, light sources 342 and a pointing device 318.

The computing device 300 may also include one or more storage devices 326, such as a hard-drive, CD-ROM, or other computer readable media, for storing data and computer-readable instructions and/or software that implement exemplary embodiments of the present disclosure (e.g., applications). For example, exemplary storage device 326 can include one or more databases 328 for storing information regarding the sounds produced by actions taking place a facility, sound signatures and locations of microphones, sound patterns, image capturing devices and light sources in a facility. The databases 328 may be updated manually or automatically at any suitable time to add, delete, and/or update one or more data items in the databases.

The computing device 300 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing device 300 and a network and/or between the computing device 300 and other computing devices. The network interface 308 may include a built-in network adapter, network interface card, PCMCIA network card, card bus network adapter, wireless network adapter, USB network adapter, modem or any other device suitable for interfacing the computing device 300 to any type of network capable of communication and performing the operations described herein.

The computing device 300 may run any operating system 310, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 300 and performing the operations described herein. In exemplary embodiments, the operating system 310 may be run in native mode or emulated mode. In an exemplary embodiment, the operating system 310 may be run on one or more cloud machine instances.

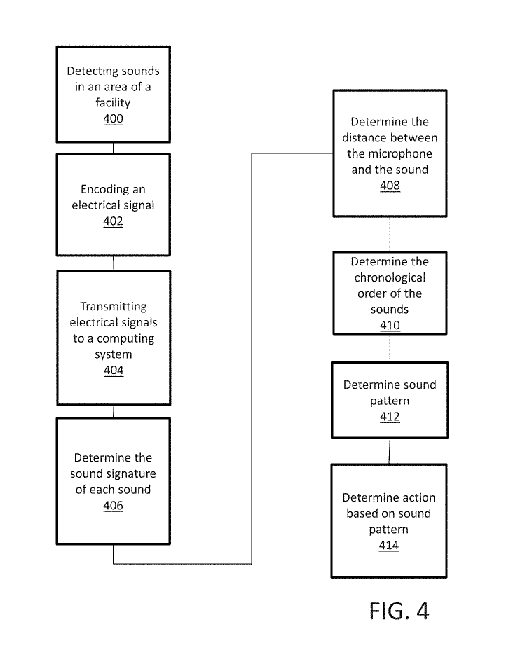

FIG. 4 is a flowchart illustrating a process implemented by an action identification system according to exemplary embodiments of the present disclosure. In operation 400, an array of microphones (e.g. microphones 102a-b shown in FIG. 1) disposed in a first location (e.g. first location 110 shown in FIG. 1) and a second location (e.g. second location 112 shown in FIG. 1) in a facility (e.g. facility shown 114 in FIG. 1) can detect sounds generated by actions performed in the first location and/or second location of the facility. The first location can include shelving units, an entrance to a loading dock (e.g. loading dock entrance 104 shown in FIG. 1), impact doors (e.g. impact doors 106 shown in FIG. 1). The first location can be adjacent to the second location. Carts can be disposed in the second location and can enter into the first location to the impact doors. The second location can include a first and second entrance (e.g. first and second entrance doors 116 and 118 shown in FIG. 1) to the facility. The sounds can be generated by the impact doors, the carts and actions occurring at the loading dock.

In operation 402, the microphones can encode each sound, intensity of the sound, and amplitude and frequency of the sound into time varying electrical signals. The intensity or amplitude of the sounds detected by the microphones can depend on the distance between the microphones and the location at which the sound originated. For example, the greater the distance a microphone is from the origin of the sound, the lower the intensity or amplitude of the sound when it is detected by the microphone. In operation 404, the microphones can transmit the encoded time varying electrical signals to the computing system. The microphones can transmit the time varying electrical signals as the sounds are detected.

In operation 406, the computing system can receive the time varying electrical signals, and in response to receiving the time varying electrical signals, the computing system can execute embodiments of the sound analysis engine (e.g. sound analysis engine 220 as shown in FIG. 2), which can decode the time varying electrical signals and extract the detected sounds (e.g., the intensities, amplitude, and frequency of the sounds). The computing system can execute the sound analysis engine to query the sound signature database (e.g. sound signature database 245 shown in FIG. 2) using the intensities, amplitudes and/or frequencies encoded in the time varying electrical signals to retrieve sound signatures corresponding to the sounds encoded in the time varying electrical signal. In operation 408, the sound analysis engine can be executed to estimate a distance between the microphones and the location of the occurrence of the sound based on the intensities or amplitudes. The sound analysis engine can be executed to determine the identification of the sounds encoded in the electrical signals based on the sound signature and the distance between the microphones and occurrence of the sound.

In operation 410, the computing system can determine a chronological order in which the identified sounds occurred based on the order in which the time varying electrical signals were received by the computing system. The computing system can also determine the time intervals between the sounds in the time varying electrical signals based on the time interval between receiving the time varying electrical signals. In operation 412, the computing system can determine a sound pattern based on the identification of the sounds, the chronological order of the sounds and the time interval between the sounds.

In operation 414, the computing system can determine the action causing the sounds detected by the array of microphones by querying the actions database (e.g. actions database 230 in FIG. 2) using the sound pattern to match a sound pattern of an action by a predetermined threshold amount (e.g., percentage).

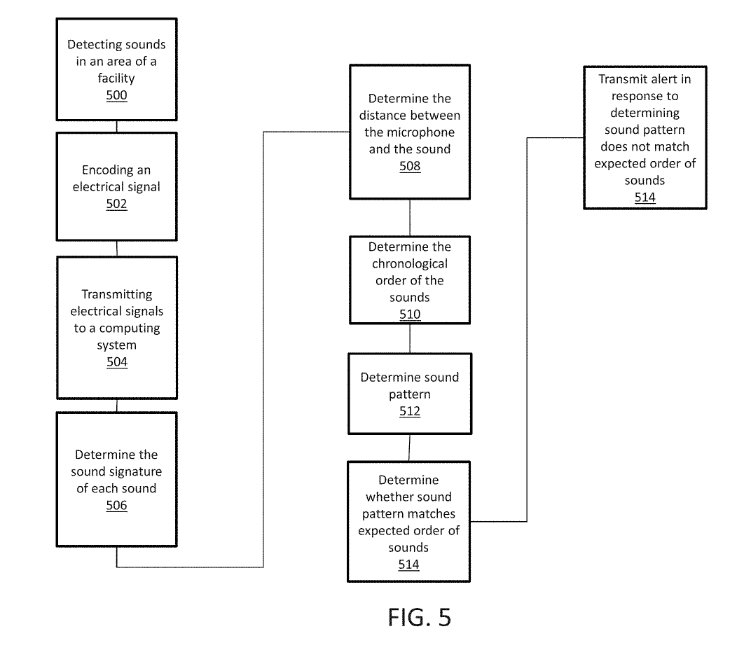

FIG. 5 is a flowchart illustrating an action identification system according to exemplary embodiments of the present disclosure. In operation 500, an array of microphones (e.g. microphones 102a-b shown in FIG. 1) disposed in a first location (e.g. first location 110 shown in FIG. 1) and a second location (e.g. second location 112 shown in FIG. 1) in a facility (e.g. facility 114 shown in FIG. 1) can detect sounds generated by actions performed in the first and/or second location of the facility. The first location can include shelving units, an entrance to a loading dock (e.g. loading dock 104 entrance shown in FIG. 1), impact doors (e.g. impact doors 106 shown in FIG. 1). The first location can be adjacent to the second location. Carts can be disposed in the second location and can enter into the first location to the impact doors. The second location can include a first and second entrance (e.g. first and second entrance doors 116 and 118 shown in FIG. 1) to the facility. The sounds can be generated by the impact doors, the carts and actions occurring at the loading dock.

In operation 502, the microphones can encode each sound detected in time varying electrical signals based on intensities, amplitudes and/or frequencies of the sounds. The intensities or amplitudes of the sounds detected by the microphones can depend on the distance between the microphones and the location at which the sound originated. For example, the greater the distance a microphone is from the origin of the sound, the lower the intensity or amplitude of the sound when it is detected by the microphone. In operation 504, the microphones can transmit the encoded time varying electrical signals to the computing system. The microphones can transmit the time varying electrical signals as the sounds are detected.

In operation 506, the computing system can receive the time varying electrical signals, and in response to receiving the time varying electrical signals, the computing system can execute embodiments of the sound analysis engine (e.g. sound analysis engine 220 as shown in FIG. 2), which can decode the time varying electrical signals and extract the detected sounds (e.g., the intensities, amplitude, and frequency of the sounds). The sound analysis engine can query the sound signature database (e.g. sound signature database 245 shown in FIG. 2) using the intensities, amplitudes and/or frequencies encoded in the time varying electrical signals to retrieve sound signatures corresponding to the sounds encoded in the time varying electrical signal. In operation 508, the sound analysis engine can estimate a distance between the microphones and the location of the occurrence of the sound based on the intensities or amplitudes. The sound analysis engine can determine the identification of the sounds encoded in the electrical signals based on the sound signature and the distance between the microphones and occurrence of the sound.

In operation 510, the sound analysis engine can determine a chronological order in which the identified sounds occurred based on the order in which the time varying electrical signals were received by the computing system. The sound analysis engine also determine the time intervals between the sounds in the time varying electrical signals based on the time interval between receiving the time varying electrical signals. In operation 512, the sound analysis engine can determine a sound pattern based on the identification of the sounds, the chronological order of the sounds and the time interval between the sounds. The sound analysis engine can determine the determined sound pattern based on the received time-varying electrical signals includes a primary sound which matches a primary sound of a sound pattern associated with an action stored in the actions database (e.g. actions database 230 in FIG. 2).

In operation 514, the sound analysis engine can determine whether a the chronological order of sounds in a sound pattern including the primary sound associated with action stored in the sounds of action database matches the chronological order of sounds in the sound pattern determined by the computing system based on the received time-varying electrical signals, by a predetermined threshold amount (e.g., percentage). In operation 516, in response to determining the chronological order of sounds in the sound pattern determined by the sound analysis engine based on the received time-varying electrical signals do not match the chronological order of sounds in a sound pattern of associated with action in the sounds of action database, issue an alert.

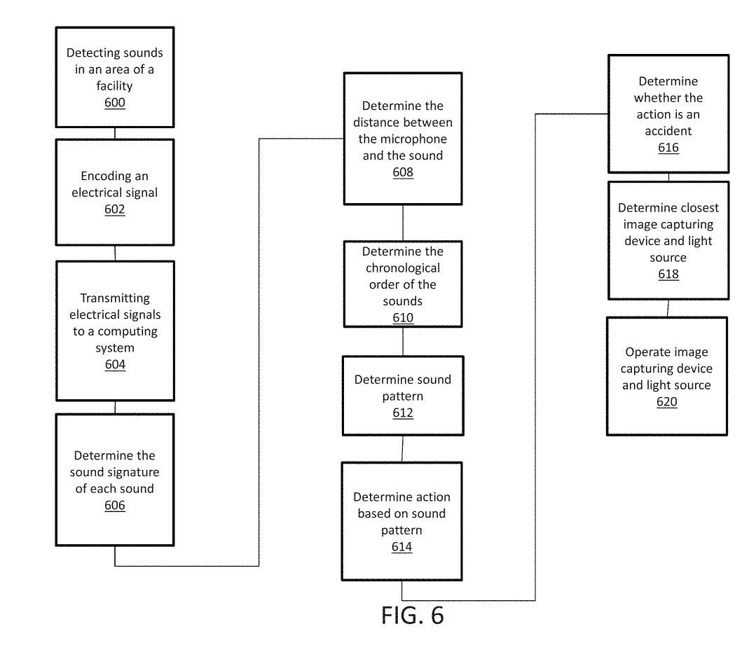

FIG. 6 is a flowchart illustrating a process implemented by an action identification system according to exemplary embodiments of the present disclosure. In operation 600, an array of microphones (e.g. microphones 102a-b shown in FIG. 1) disposed in first and second location (e.g. first location 110 and second location 112 shown in FIG. 1) in a facility (e.g. facility shown 114 in FIG. 1) can detect sounds generated by actions performed in the first location of the facility. The first location can include shelving units, an entrance to a loading dock (e.g. loading dock entrance 104 shown in FIG. 1), impact doors (e.g. impact doors 106 shown in FIG. 1). The first location can be adjacent to a second location (e.g. second location 112 shown in FIG. 1). Carts can be disposed in the second location and can enter into the first location to the impact doors. The second location can include a first and second entrance (e.g. first and second entrance doors 116 and 118 shown in FIG. 1) to the facility. The sounds can be generated by the impact doors, the carts and actions occurring at the loading dock.

In operation 602, the microphones can encode each sound, intensity of the sound, and amplitude and frequency of the sound into time varying electrical signals. The intensity or amplitude of the sounds detected by the microphones can depend on the distance between the microphones and the location at which the sound originated. For example, the greater the distance a microphone is from the origin of the sound, the lower the intensity or amplitude of the sound when it is detected by the microphone. In operation 604, the microphones can transmit the encoded time varying electrical signals to the computing system. The microphones can transmit the time varying electrical signals as the sounds are detected.

In operation 606, the computing system can receive the time varying electrical signals, and in response to receiving the time varying electrical signals, the computing system can execute embodiments of the sound analysis engine (e.g. sound analysis engine 220 as shown in FIG. 2), which can decode the time varying electrical signals and extract the detected sounds (e.g., the intensities, amplitude, and frequency of the sounds). The computing system can execute the sound analysis engine to query the sound signature database (e.g. sound signature database 245 shown in FIG. 2) using the intensities, amplitudes and/or frequencies encoded in the time varying electrical signals to retrieve sound signatures corresponding to the sounds encoded in the time varying electrical signal. In operation 608, the sound analysis engine can be executed to estimate a distance between the microphones and the location of the occurrence of the sound based on the intensities or amplitudes. The sound analysis engine can be executed to determine the identification of the sounds encoded in the electrical signals based on the sound signature and the distance between the microphones and occurrence of the sound.

In operation 610, the computing system can determine a chronological order in which the identified sounds occurred based on the order in which the time varying electrical signals were received by the computing system. The computing system can also determine the time intervals between the sounds in the time varying electrical signals based on the time interval between receiving the time varying electrical signals. In operation 612, the computing system can determine a sound pattern based on the identification of the sounds, the chronological order of the sounds and the time interval between the sounds.

In operation 614, the computing system can determine the action causing the sounds detected by the array of microphones by querying the actions database (e.g. actions database 230 in FIG. 2) using the sound pattern to match a sound pattern of an action by a predetermined threshold amount (e.g., percentage). In operation 616, the computing system can determine whether the action is an accident that occurred in the facility. In operation 618, in response to determining the action is an accident, the computing system can determine closest of the image capturing devices (e.g. image capturing devices 122a-f as shown in FIGS. 1 and 2) and/or the closest light source (e.g. light sources 124a-f as shown in FIGS. 1 and 2) to the generated sounds by querying the facilities database (e.g. facilities database 265 as shown in FIG. 2) using the determined location of the generated sounds. In operation 620, the computing system can instruct the determined closest image capturing device to capture an image of the location of the generated sounds and/or operate the determined closest light source(s) to power on. In some embodiments, the computing system 200 can execute the video analytics engine (e.g. video analytics engine 270 as shown in FIG. 2) to analyze the image of the captured image using video analytics to confirm the identified action occurred in the determined location. In some embodiments, the image can be transmitted as an alert.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A system for identifying actions based on detected sounds, the system comprising:
an array of microphones disposed in a first area of a facility, the microphones being configured to detect sounds and output time varying electrical signals upon detection of the sounds; and
a computing system operatively coupled to the microphones and a data storage device, the computing system programmed to:
receive the time varying electrical signals from microphones;
identify the sounds detected by the microphones based on the time varying electric signals;
determine time intervals between the sounds encoded in the time varying electrical signals;
identify an action that produced at least some of the sounds in response to identifying the sounds and determining the time intervals between the sounds; and
issue an alert based on the action.

2. The system in claim 1, wherein the microphones are further configured to detect intensities of the sounds and encode the intensities of the sounds in the time varying electrical signals.

3. The system in claim 2, wherein the computing system is further programmed to determine a distance between at least one of the microphones and an origin of at least one of the sounds based on the intensity of the at least one of the sounds detected by at least a subset of the microphones, the subset including the at least one of the microphones.

4. The system in claim 1, wherein the computing system determines a chronological order in which the sounds are detected by the microphones based on when the computing system receives the electrical signals.

5. The system in claim 4, wherein the computing system is programmed to identify the action that produced at least some of the sounds based on matching the chronological order in which the sounds are detected to a set of sound patterns.

6. The system of claim 4, wherein the computing system is programmed to identify the action that produced at least some of the sounds based on the chronological order matching a threshold percentage of a sound pattern in a set of sound patterns.

7. The system in claim 1, wherein the microphones are further configured to detect amplitude and frequency of the sounds and encode the amplitude and the frequency in the time varying electrical signals.

8. The system in claim 7, wherein the computing system determines sound signatures based on the amplitude and the frequency encoded in each electrical signal, the sound signatures being utilized to identify the sounds.

9. The system of claim 1, further comprising a plurality of image capturing devices in communication with the computing system, disposed throughout the facility and configured to capture images.

10. The system of claim 9, wherein the computing system is programmed to:
identify at least one of the plurality of the image capturing devices located within proximity of the location of the action; and
trigger the at least one of the plurality of the image capturing device to capture an image of the location at which the action occurred.

11. A method for identifying actions based on detected sounds, the method comprising:
detecting sounds via an array of microphones disposed in a first area of a facility;
receiving, via a computing system, time varying electrical signals output by the microphones in response to detection of the sounds;
determining time intervals between the sounds encoded in the time varying electrical signals;
identifying an action that produced at least some of the sounds in response to identifying the sounds and determining the time intervals between the sounds; and
issuing an alert based on the action.

12. The method in claim 11, further comprising:
detecting, via the microphones, intensities of the sounds; and
encoding the intensities of the sounds in the time varying electrical signals.

13. The method in claim 12, further comprising determining, via the computing system, a distance between at least one of the microphones and an origin of at least one of the sounds based on the intensity of the at least one of the sounds detected by at least a subset of the microphones, the subset including the at least one of the microphones.

14. The method in claim 13, further comprising determining, via the computing system, a chronological order in which the sounds are detected by the microphones based on when the computing system receives the electrical signals.

15. The method in claim 14, further comprising identifying, via the computing system, the action that produced at least some of the sounds based on matching the chronological order in which the sounds are detected to a set of sound patterns.

16. The method of claim 15, further comprising identifying, via the computing system, the action that produced at least some of the sounds based on the chronological order matching a threshold percentage of a sound pattern in a set of sound patterns.

17. The method in claim 16, further comprising:
detecting via the microphones, an amplitude and a frequency of each of the sounds; and
encoding the amplitude and the frequency in the time varying electrical signals.

18. The method in claim 17, further comprising determining, via the computing system, sound signatures associated with the sounds detected by the microphones based on the amplitude and the frequency encoded in each of the time varying electrical signals, the sound signatures being utilized to identify the sounds.

19. The method of claim 10, further comprising capturing, via a plurality of image capturing devices in communication with the computing system, disposed throughout the facility images.

20. The method of claim 19, further comprising:
identifying, via the computing system, at least one of the plurality of the image capturing devices located within proximity of the location of the action; and
triggering, via the computing system, the at least one of the plurality of the image capturing device to capture an image of the location at which the action occurred.

21. A system for identifying actions based on the chronological order of detected sounds, the system comprising:
an array of microphones disposed in a first area of a facility, the microphones being configured to detect sounds and output time varying electrical signals upon detection of the sounds; and
a computing system operatively coupled to the array of microphones, the computing system programmed to:
receive the time varying electrical signals associated with the sounds detected by at least a subset of the microphones;
identify the sounds detected by the subset of the microphones based on the time varying electric signals;
determine time intervals between the sounds encoded in the time varying electrical signals;
determine a chronological order in which the sounds encoded in the time varying electrical signals are detected by the microphones; and
identify an action that produced at least some of a sequence of the sounds in response to identifying the sounds, determining the time intervals between the sounds, and determining the chronological order in which the time varying electrical signals associated with the sounds are received.

22. A system for triggering a response based on identification of actions based on detected sounds, the system comprising:
an array of microphones disposed throughout a facility, the microphones being configured to detect sounds and output time varying electrical signals upon detection of the sounds;
a plurality of image capturing devices disposed throughout the facility and configured to capture images;
a computing system operatively coupled to the array of microphones and the plurality of image capturing devices, the computing system programmed to:
receive the time varying electrical signals associated with the sounds detected by at least a subset of the microphones;
identify the sounds detected by the subset of the microphones based on the time varying electric signals;
identify an action that produced at least some of the sounds in response to identifying the sounds;
determine a location of the action in the facility;
identify at least one of the plurality of the image capturing devices located within proximity of the location of the action; and
trigger the at least one of the plurality of the image capturing device to capture an image of the location at which the action occurred.
